(19) United States
(12) Patent Application Publication
(10) Pub. No.: US 2012/0061585 A1
(43) Pub. Date: Mar. 15, 2012

(54) ULTRAVIOLET WATER TREATING APPARATUS

(76) Inventors: Takeshi IDE, Kokubunji-shi (JP); Norimitsu ABE, Kawasaki-shi (JP); Seiichi MURAYAMA, Fuchu-shi (JP); Shinji KOBAYASHI, Yokohama-shi (JP); Kenji TAKEUCHI, Fuchu-shi (JP); Takahiro SOMA, Kawasaki-shi (JP)

(21) Appl. No.: 13/231,567

(22) Filed: Sep. 13, 2011

(30) Foreign Application Priority Data
Sep. 15, 2010 (JP) 2010-207181

(51) Int. Cl. C02F 1/32

(52) U.S. Cl. 250/431

(57) ABSTRACT

An ultraviolet water treating apparatus according to one embodiment has an ultraviolet irradiation unit, and water inlet and outlet pipes. The unit includes a hollow enclosure with first and second openings in its peripheral wall. Within the enclosure, one or more ultraviolet irradiation devices are provided, which irradiate ultraviolet light onto the water flowing through the enclosure. Also within the enclosure, a cleaning device is provided, which includes a cleaning tool to clean the surface of each protective sleeve, and a driving unit to move the cleaning tool along the protective sleeve. The inlet pipe is in fluid communication with the first opening and flows the water therethrough into the enclosure. The outlet pipe is in fluid communication with the second opening and flows the ultraviolet-irradiated water therethrough out of the enclosure. The inlet and outlet pipes have their central axes intersected with the central axis of the enclosure.

### CROSS-REFERENCE TO RELATED APPLICATIONS

This application is based upon and claims the benefit of priority from prior Japanese Patent Application No. 2010-207181, filed Sep. 15, 2010, the entire contents of which are incorporated herein by reference.

### FIELD

Embodiments described herein relate generally to an ultraviolet water treating apparatus.

### BACKGROUND

Ultraviolet light is capable of, e.g., disinfecting, sterilizing and decoloring water and sewage, decomposing hard-to-decompose organic matters, deodorizing industrial water, and bleaching pulps, and exerts such effects within several seconds of irradiation. In an ultraviolet water treating apparatus, ultraviolet lamps are sometimes penetrated through a conduit through which water to be treated flows such that the lamps are arranged perpendicular to the conduit. On the other hand, it is known that ultraviolet lamps are penetrated through a conduit through which water to be treated flows such that the lamps are arranged aslant to the conduit. The aslant arrangement of the lamps makes it possible to use longer ultraviolet lamps.

However, it is difficult to precisely arrange ultraviolet lamps such that the lamps cross a conduit through which water to be treated.

### BRIEF DESCRIPTION OF THE DRAWINGS

FIG. 1A is a schematic sectional view illustrating an ultraviolet water treating apparatus according to a first embodiment;

FIG. 1B is a view when the apparatus of FIG. 1A is viewed from the direction of an arrow A;

FIG. 2 a view for explaining an angle at which inlet and outlet pipes are fixed to a hollow enclosure of an ultraviolet irradiation unit;

FIG. 3A is a schematic sectional view illustrating an ultraviolet water treating apparatus according to a second embodiment;

FIG. 3B is a view when the apparatus of FIG. 3A is viewed from the direction of an arrow A;

FIG. 4A is a schematic sectional view illustrating an ultraviolet water treating apparatus according to a third embodiment; and

FIG. 4B is a view when the apparatus of FIG. 4A is viewed from the direction of an arrow A.

### DETAILED DESCRIPTION

An ultraviolet water treating apparatus according to one embodiment comprises an ultraviolet irradiation unit, water inlet pipe configured to introduce water to be treated into the ultraviolet irradiation unit, and a water outlet pipe configured to flow the water irradiated with ultraviolet light out of the ultraviolet irradiation unit. The ultraviolet irradiation unit comprises a hollow enclosure having a peripheral wall provided with first and second openings provided oppositely with each other in the peripheral wall. Within the enclosure, one or more ultraviolet irradiation devices are provided, each of which comprises an ultraviolet lamp and a protective sleeve surrounding the ultraviolet lamp coaxially with the lamp, and which are provided parallel to each other. The ultraviolet irradiation device irradiates ultraviolet light onto the water flowing through the hollow enclosure. Also within the enclosure, a protective sleeve-cleaning device is provided which comprises one of more cleaning tools each configured to clean the surface of the protective sleeve, and a driving unit configured to drive the cleaning tool to move it along the protective sleeve. The water inlet pipe is in fluid communication directly with the first opening and flows the water therethrough into the hollow enclosure. The water outlet pipe is in fluid communication directly with the second opening and flows the ultraviolet-irradiated water therethrough out of the hollow enclosure. The water inlet pipe has its central axis intersected with the central axis of the enclosure, and the water outlet pipe has its central axis intersected with the central axis of the enclosure.

Ultraviolet water treating apparatuses according to various embodiments will be described below with reference to the appended drawings.

### First Embodiment

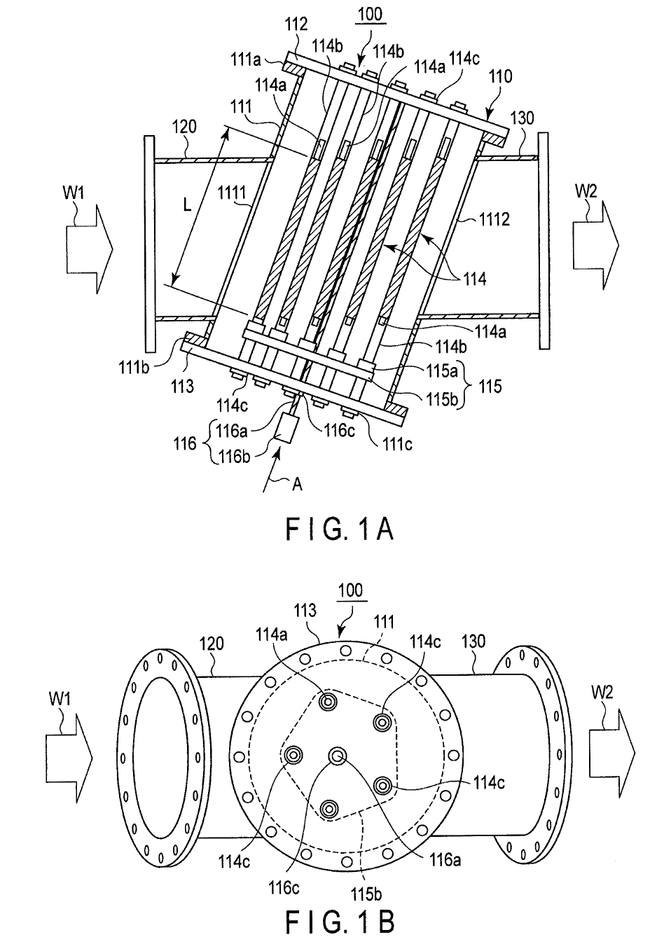

An ultraviolet water treating apparatus 100 according to a first embodiment will be described with reference to FIGS. 1A and 1B. FIG. 1A is a schematic sectional view illustrating the ultraviolet water treating apparatus 100. FIG. 1B is a view when the apparatus 100 of FIG. 1A is viewed from the direction of an arrow A.

The ultraviolet water treating apparatus 100 comprises an ultraviolet irradiation unit 110, an inlet pipe 120 for water to be treated, and an outlet pipe 130 for treated water, arranged on the same axis as the inlet pipe 120.

The ultraviolet irradiation unit 110 has a hollow cylindrical enclosure (hollow cylinder) 111 open at its both ends and having a constant inner diameter. The central axis of the hollow cylinder 111 is perpendicular to the plane including one open end of the cylinder 111 and to the plane including the other open end of the cylinder 111. A first opening 1111 and a second opening 1112 are oppositely provided in the peripheral wall of the cylinder 111.

At the both open ends of the cylinder 111, flanges 111a and 111b are formed, extending in the direction perpendicular to the peripheral wall of the cylinder 111. On these flanges 111a and 111b, a first lid 112 and a second lid 113, each circular in plan, are detachably fixed by means of, e.g., screw, water-tightly through a rubber gasket (not illustrated). Needless to say, the central axis of the cylinder 111 is perpendicular to the circular planes of the lids 112 and 113. The lids 112 and 113 and the peripheral wall of the cylinder 111 forms a sealed space.

Within the cylinder 111, one or more (five in FIGS. 1A and 1B) ultraviolet irradiation device 114 are provided parallel to each other and to the central axis of the cylinder 111. Each ultraviolet irradiation device 114 comprises an ultraviolet lamp 1141 and a protective sleeve or tube 114b arranged around the ultraviolet lamp 114a coaxially therewith. The emission portion of the ultraviolet lamp 114a is shaded. Each ultraviolet irradiation device 114 penetrates through the lids 112 and 113, and is fixed at fixing portions 114c.

In order not to attach dusts or dirts to the surface of the protective sleeve 114b or to clean the dusts or dirts off the surface of the protective sleeve 114b when the surface becomes dirty, a cleaning device 115 to clean the protective sleeve is provided within the cylinder 111. The cleaning device 115 comprises cleaning tools (e.g., brush or wiper) 115a each surrounding each protective sleeve 114b and a fixing plate 115b which supports and fixes all the cleaning tools 115a. The fixing plate 115b is, e.g., pentangular in plan as illustrated in FIG. 1B. The fixing plate 115b is moved by a driving mechanism 116 comprising a fixing plate-moving shaft 116a having thread groove formed in its peripheral surface and penetrating through the centers of the fixing plate 115b and the lids 112 and 113, parallel to the central axis of the cylinder 111, and a driving motor 116b provided outside the cylinder 111 and rotating the shaft 116a. The shaft 116a penetrates through the lids 112 and 113 and fixed to the lids 112 and 113 at fixing portions 116c.

The inlet pipe 120 for the water W1 to be treated is connected to the first opening 1111 provided in the peripheral wall of the cylinder 111, and the outlet pipe 130 for the ultraviolet light-irradiated water W2 is connected to the second opening 1112. The inlet pipe 120 and the outlet pipe 130 are arranged on the same axis (i.e., the central axis of the inlet pipe 120 coincides with the central axis of the outlet pile 130). The outer diameters of the inlet pipe 120 and the outlet pipe 130 are smaller than the outer diameter of the cylinder 111. In one embodiment, the inner diameters of the inlet pipe 120 and the outlet pipe 130 are the same, as illustrated in FIG. 1A.

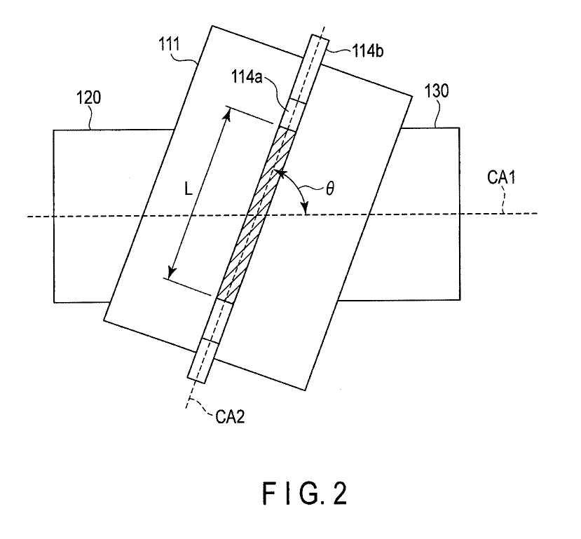

Further, as illustrated in FIG. 2, the inlet pipe 120 and the outlet pipe 130 are connected to the cylinder 111 such that their central axes CA1 intersect with the central axis of the cylinder 111 and hence the central axis CA2 of the ultraviolet lamp 114a (and the protective sleeve 114b), i.e., such that their central axes CA1 form an angle θ with the central axis CA2. Incidentally, FIG. 1 is a simplified form of FIG. 2, and only one ultraviolet lamp 114a and only one protective sleeve 114b are depicted for simplicity. In FIG. 2 (also in FIG. 1A), the emission length of the ultraviolet lamp 114a is indicated by a reference symbol “L”.

In one or more embodiments, the inner diameter of the pipe (i.e., inlet pipe 120 and outlet pipe having the same inner diameter), the maximum throughput of an ultraviolet water treating apparatus at various flow rates of water flowing through the pipe and the angle θ formed between the axis of the ultraviolet lamp of various specifications and the axis of the pipe are exemplified in Table 1 below.

TABLE 1

| | | | Angle θ (degree) formed | | | | | |
|---|---|---|---|---|---|---|---|---|
| | | | between lump axis and pipe axis | | | | | |
| | Maximum throughput | | P = 3 | | P = 6 | | P = 10 | |
| I.D. of | Fₘₐₓ(m³/day) | | W = 0.1 | W = 0.3 | W = 0.1 | W = 0.3 | W = 0.1 | W = 0.3 |
| pipe | FR = 2 | FR = 3 | L = 30 | L = 10 | L = 60 | L = 20 | L = 100 | L = 33 |
| 10 cm | 1357 | 2036 | 19 | 90 | 10 | 30 | 6 | 17 |
| 15 cm | 3054 | 4580 | 30 | 90 | 14 | 49 | 9 | 27 |
| 20 cm | 5429 | 8143 | 42 | 90 | 19 | 90 | 12 | 37 |
| 25 cm | 8482 | 12723 | 56 | 90 | 25 | 90 | 14 | 49 |
| 30 cm | 12215 | 18322 | 90 | 90 | 30 | 90 | 17 | 64 |
| 35 cm | 16625 | 24938 | 90 | 90 | 36 | 90 | 20 | 90 |
| 40 cm | 21715 | 32572 | 90 | 90 | 42 | 90 | 24 | 90 |
| 45 cm | 27483 | 41224 | 90 | 90 | 49 | 90 | 27 | 90 |
| 50 cm | 33929 | 50894 | 90 | 90 | 56 | 90 | 30 | 90 |
| 55 cm | 41054 | 61581 | 90 | 90 | 66 | 90 | 33 | 90 |
| 60 cm | 48858 | 73287 | 90 | 90 | 90 | 90 | 37 | 90 |
| 65 cm | 57340 | 86011 | 90 | 90 | 90 | 90 | 41 | 90 |
| 70 cm | 66501 | 99752 | 90 | 90 | 90 | 90 | 44 | 90 |
| 75 cm | 76341 | 114511 | 90 | 90 | 90 | 90 | 49 | 90 |
| 80 cm | 86859 | 130288 | 90 | 90 | 90 | 90 | 53 | 90 |
| 85 cm | 98055 | 147083 | 90 | 90 | 90 | 90 | 58 | 90 |
| 90 cm | 109931 | 164896 | 90 | 90 | 90 | 90 | 64 | 90 |
| 95 cm | 122484 | 183727 | 90 | 90 | 90 | 90 | 72 | 90 |
| 100 cm | 135717 | 203575 | 90 | 90 | 90 | 90 | 90 | 90 |

Note:
I.D. = inner diameter;
FR = maximum flow rate (m/s);
P = lump specification (kW) ;
W = input specification per emission length (kW/cm);
L = lump emission length

As shown in Table 1, when the emission length of the ultraviolet lamp is larger than the inner diameter of the inlet pipe/outlet pipe, the inlet pipe/outlet pipe is connected to the cylinder 111 such that the axis of the ultraviolet lamp and the axis of the inlet pipe/outlet pipe form an angle θ of less than 90 degrees. On the other hand, when the emission length of the ultraviolet lamp is not larger than the inner diameter of the inlet pipe/outlet pipe, the inlet pipe/outlet pipe is connected to the cylinder 111 such that the axis of the ultraviolet lamp and the axis of the inlet pipe/outlet pipe form an angle θ of 90 degrees. As a result, not only when the emission length L of the lamp is not larger than the inner diameter of the inlet pipe 120/outlet pipe 130, but also when the emission length L of the lamp is larger than the inner diameter of the inlet pipe 120/outlet pipe 130, the emission portion (length L) of the lamp 114a may be positioned within the projected outline (circle), of the inlet pipe 120/outlet pipe 130, onto a plane perpendicular to the peripheral wall. In this case, the position of the lamp 114a within the protective sleeve 114b may be set such that the emission portion (length L) of the lamp is positioned within said projected outline. As a result, the all of the ultraviolet light emitted from the ultraviolet lamps 114a can be effectively irradiated onto the water W1 to be treated, carrying out disinfection (sterilization) treatment efficiently.

Incidentally, even when the emission length L is smaller than the inner diameter of inlet pipe/outlet pipe, the angle θ may be set at 90 degrees.

In this embodiment, the ultraviolet lamp 114a is preferably provided by a medium-pressure ultraviolet lamp, i.e., an ultraviolet lamp with an input per emission length of 0.08 kW/cm to 0.3 kW/cm, rather than a low-pressure ultraviolet lamp. When a low-pressure lamp is used as the ultraviolet lamp 114a, it is necessary to accommodate, in the ultraviolet irradiation unit, 10 or more times as many as ultraviolet lamps as compared with the case where an ultraviolet lamp having an output of several kW to several tens kW is used. However, in this case, the accommodation is difficult, and results in a complicated structure. The low-pressure ultraviolet lamp has an input per emission length of about 0.001 kW/cm, and is made longer than a medium-pressure ultraviolet lamp. Therefore, the inlet and outlet pipes must be connected to the ultraviolet irradiation unit at a very acute angle (10 degrees or less), making it difficult to connect the pipes to the ultraviolet irradiation unit. When a medium-pressure ultraviolet lamp having an input per emission length of 0.08 kW/cm to 0.3 kW/cm is used, the angle θ may be set at 30 to 90 degrees as indicated in Table 1, making it possible to easily connect the inlet and outlet pipes 120 and 130 to the cylinder 111.

It should be noted here that, as can be understood from the above description, the hollow cylinder 111, the lids 112 and 113, the ultraviolet irradiation device 114, the cleaning device 115, and the driving mechanism 116 are constructed as one united or integrated unit (the ultraviolet irradiation unit described above), and the ultraviolet irradiation unit is fabricated separately from the inlet pipe 120 and the outlet pipe 130. Since the ultraviolet irradiation device 114 and the shaft 116a are arranged parallel to the peripheral wall of the hollow cylinder 111 and perpendicular to the lids 112 and 113, the ultraviolet irradiation device 114 and the shaft 116a can be provided within the hollow cylinder 111 with high precision. In addition, it is easy to mount the inlet pipe 120 and the outlet pipe 130 aslant to the ultraviolet irradiation unit provided as one integrated unit. In other words, the ultraviolet lamps 114a can be easily arranged aslant to the central axes of the inlet pipe 120 and the outlet pipe 130. Further, since the lids 112 and 113 are detachably mounted on the hollow cylinder 111, the maintenance of the structural elements within the ultraviolet irradiation unit 110 (or within the hollow cylinder 111), in particular, the cleaning device, becomes easy.

When the water is treated with the ultraviolet water treating apparatus 100, the water W1 to be treated flows through the inlet pipe 120 into the hollow cylinder 111 of the apparatus. The water W1 flows through the hollow cylinder 111 while being irradiated with ultraviolet light emitted from the ultraviolet lamps 114, and flows through the outlet pipe 130 out of the cylinder 111 as the treated water W2. When the driving motor 116b is driven, the shaft 116a connected to the motor 116b is rotated, and the fixing plate 115b is moved along the shaft 116a and within the hollow cylinder 111. When the shaft 116a is rotated in one direction, the fixing plate 115b moves upwards along the shaft 116a. On the other hand, when the shaft 116a is rotated in the opposite direction, the fixing plate 115b moves downwards along the shaft 116a. With the upward and downward movement of the fixing plate 115b, the cleaning tool 115a moves upwards and downwards so as to rub the surface of the protective sleeve 114b. In this way, the surface of the protective sleeve 114b is cleaned.

Incidentally, the outer diameter of the hollow cylinder 111 is larger than the outer diameter of the inlet pipe 120/outlet pipe 130 in the first embodiment. However, the outer diameter of the hollow cylinder 111 may be the same as the outer diameter of the inlet pipe 120/outlet pipe 130.

Further, the enclosure is provided by the hollow cylinder, but the enclosure may be provided by a hollow rectangular parallelepiped. In this case, the inlet pipe and the outlet pipe are connected to the two walls of the rectangular parallelepiped which are perpendicular to the open upper ends of the rectangular parallelepiped and face with each other.

### Second Embodiment

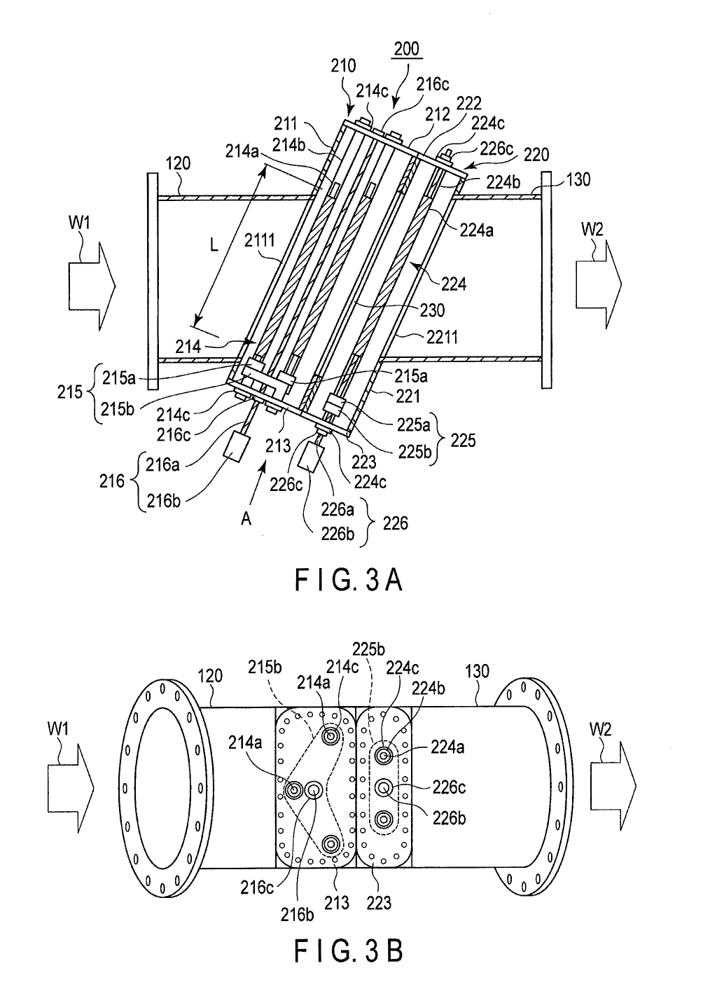

An ultraviolet water treating apparatus 200 according to a second embodiment will be described below with reference to FIGS. 3A and 3B. FIG. 3A is a schematic sectional view illustrating the ultraviolet water treating apparatus 200. FIG. 3B is a view when the apparatus 200 of FIG. 3A is viewed from the direction of an arrow A. In FIGS. 3A and 3B, the same or similar elements as in FIGS. 1A and 1B are labeled with the same reference symbols, and detailed descriptions thereof will be omitted.

The ultraviolet water treating apparatus 200 has a structure similar to that of the apparatus described with reference to FIGS. 1A and 1B, except that the ultraviolet irradiation unit is constituted by a plurality (two in FIGS. 3A and 3B) of box-shaped ultraviolet irradiation subunits provided in series.

The first box-shaped ultraviolet irradiation subunit 210 constituting the box-shaped ultraviolet irradiation unit comprises an enclosure in the form of hollow rectangular parallelepiped open at both ends. At the both open ends of the enclosure 211, a first lid 212 and a second lid 213, each rectangular in plan, are detachably fixed by means of, e.g., screw, water-tightly through a rubber gasket (not illustrated). Needless to say, the central axis of the enclosure 211 is perpendicular to the rectangular planes of the lids 212 and 213. The lids 212 and 213 and the peripheral wall of the parallelepiped 211 forms a sealed space.

Within the parallelepiped 211, one or more (three in FIGS. 3A and 3B) ultraviolet irradiation devices 214 are provided parallel to each other and to the central axis of the parallelepiped 211, as in the ultraviolet water treating apparatus 100 illustrated in FIGS. 1A and 1B. Each ultraviolet irradiation device 214 comprises an ultraviolet lamp 214a and a protective sleeve or tube 214b arranged around the ultraviolet lamp 214a coaxially therewith, as in the ultraviolet irradiation device 114 described above. The emission portion of the ultraviolet lamp 214a is shaded. Each ultraviolet irradiation device 214 penetrates through the lids 212 and 213, and is fixed at fixing portions 214c.

A cleaning device 215 to clean the protective sleeve is provided within the parallelepiped 211, as in the ultraviolet irradiation unit 110 described above. The cleaning device 215 comprises one or more cleaning tools (e.g., brush or wiper) 215a each surrounding each protective sleeve 214b, and a fixing plate 215b which supports and fixes all the cleaning tools 215a. The fixing plate 215b is moved by driving mechanism 216 comprising a fixing plate-moving shaft 216a having thread groove formed in its peripheral surface and penetrating through the centers of the fixing plate 215b and the lids 212 and 213, parallel to the central axis of the parallelepiped 211, and a driving motor 216b provided outside the parallelepiped 211 and rotating the shaft 216a. The shaft 216a penetrates through the lids 212 and 213 and is fixed to the lids 212 and 213 at fixing portions 216c.

In one wall of the hollow rectangular parallelepiped enclosure 211, an opening 2111 is provided, at which the inlet pipe 120 is connected.

The second ultraviolet irradiation subunit 220 has a structure similar to the first ultraviolet irradiation subunit 210. That is, the second ultraviolet irradiation subunit 220 comprises an enclosure in the form of a hollow rectangular parallelepiped open at both ends. The parallelepiped enclosure 221 has the same height and depth as the parallelepiped enclosure 211, but has a smaller width. At the both open ends of the enclosure 221, a first lid 222 and a second lid 223, each rectangular in plan, are detachably fixed by means of, e.g., screw, water-tightly through a rubber gasket (not illustrated). Needless to say, the central axis of the enclosure 221 is perpendicular to the rectangular planes of the lids 222 and 223. The lids 222 and 223 and the peripheral wall of the parallelepiped 221 forms a sealed space.

Within the parallelepiped 221, one or more (two in FIGS. 3A and 3B) ultraviolet irradiation devices 224 are provided parallel to each other and to the central axis of the parallelepiped 221, as in the ultraviolet water treating apparatus illustrated 100 in FIGS. 1A and 1B. Each ultraviolet irradiation device 224 comprises an ultraviolet lamp 224a and a protective sleeve or tube 224b arranged around the ultraviolet lamp 224a coaxially therewith, as in the ultraviolet irradiation device 114 described above. The emission portion of the ultraviolet lamp 224a is shaded. Each ultraviolet irradiation device 224 penetrates through the lids 222 and 223, and is fixed at fixing portions 224c.

A cleaning device 225 to clean the protective sleeve is provided within the parallelepiped 221, as in the ultraviolet irradiation unit 110 described above. The cleaning device 225 comprises one or more cleaning tools (e.g., brush or wiper) 225a each surrounding each protective sleeve 224b and a fixing plate 225b which supports and fixes all the cleaning tools 225a. The fixing plate 225b is moved by driving mechanism 226 comprising a fixing plate-moving shaft 226a having thread groove formed in its peripheral surface and penetrating through the centers of the fixing plate 225b and the lids 222 and 223, parallel to the central axis of the parallelepiped 211, and a driving motor 226b provided outside the parallelepiped 221 and rotating the shaft 226a. The shaft 226a penetrates through the lids 222 and 223 and is fixed to the lids 222 and 223 at fixing portions 226c.

In one wall of the hollow rectangular parallelepiped enclosure 221, an opening 2211 is provided, at which the outlet pipe 130 is connected.

The two ultraviolet irradiation subunits 210 and 220 are welded together at the wall surface of the former which faces the wall to which the inlet pipe 120 is connected and the wall surface of the latter which faces the wall to which the outlet pipe 130 is connected. In the welded walls, an opening 30 is bored, through which the insides of the first and second ultraviolet irradiation subunits 210 and 220 communicate with each other. Each of the welded walls forms a kind of frame.

The inlet pipe 120 is connected to the first box-shaped ultraviolet irradiation subunit 210 such that its central axis forms an angle θ with the central axes of the ultraviolet lamp 214a and the protective sleeve 214b (or the central axis of the parallelepiped 211). The angle θ is the same as in the first embodiment. As indicated in Table 1 above, the inlet pipe 120 is fixed such that the angle θ becomes leas than 90 degrees, when the emission length L of the ultraviolet lamp 214a is larger than the inner diameter of the inlet pipe 120.

On the other hand, when the emission length L is smaller than the inner diameter of the inlet pipe 120, the angle θ is set at 90 degrees. That is, the inlet pipe 120 is connected to the parallelepiped 211 of the ultraviolet irradiation subunit 210 such that the central axis of the former and the central axis of the latter intersect at right angles. However, even when the emission length L is smaller than the inner diameter of the inlet pipe 120, the angle θ may be set at less than 90 degrees. Further, the positions of the ultraviolet lamps 214a within the protective sleeves 214b may be properly set so that the emission portions (emission length L) of the ultraviolet lamps 214a are positioned within the projected outline (explained above) of the inlet pipe 120.

Likewise, the outlet pipe 130 is connected to the second box-shaped ultraviolet irradiation subunit 220 such that its central axis forms an angle θ with the central axes of the ultraviolet lamp 224a and the protective sleeve 224b (or the central axis of the parallelepiped 221). The angle θ may be set as in the first ultraviolet irradiation subunit 210.

In the second embodiment, each of the ultraviolet lamp 214a and 215a is preferably provided by a medium-pressure ultraviolet lamp, i.e., an ultraviolet lamp with an input per emission length of 0.08 kW/cm to 0.3 kW/cm, rather than a low-pressure ultraviolet lamp, as in the first embodiment.

The ultraviolet water treating apparatus 200 according to the second embodiment may be operated as the ultraviolet water treating apparatus 100 according to the first embodiment, and thus detailed description on the operation is omitted.

According to the second embodiment, the same advantages as in the first embodiment can be exerted. However, since the ultraviolet irradiation unit is box-shaped, the inlet and outlet pipes 120 and 130, ultraviolet lamps 214a and 215a, protective sleeves 214b and 215b, and shafts 216a and 226a can be fixed to the ultraviolet irradiation unit by easier fabrication operations and with higher precision. Further, a plurality of ultraviolet irradiation subunits may be welded in series. Thus, the box-shaped ultraviolet irradiation subunits differing in the number of the ultraviolet lamps may be combined in view of the throughput, radiation dosage of ultraviolet light (determined by microorganisms to be disinfected), and ultraviolet transmissivity of the water to be treated. As a result, the manufacturing costs may be reduced.

In the second embodiment, the depths of the rectangular parallelepiped enclosures 210 and 220 are equal to the outer diameters of the inlet and outlet pipes 120 and 130, as illustrated in FIG. 3B. These depths may be made larger than the outer diameters of the inlet and outlet pipes 120 and 130. As a result, the connections of the inlet and outlet pipes 120 and 130 to the ultraviolet irradiation subunits become easier. Alternatively, the depths noted above may be made smaller than the inner diameters of the inlet and outlet pipes 120 and 130. In this case, the inlet pipe 120 and the outlet pipe 130 may constitute a single conduit, and the ultraviolet irradiation unit constituted by the ultraviolet irradiation subunits 210 and 220 may be inserted into the conduit, as in a third embodiment which will be described below. In this case, the same advantages as in the third embodiment may be obtained.

### Third Embodiment

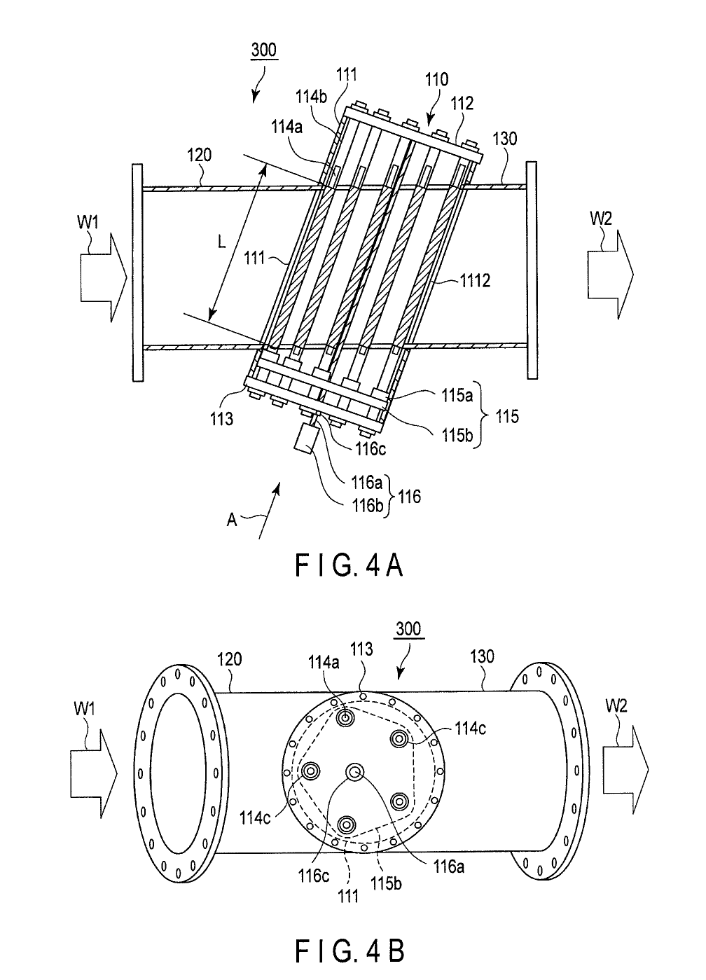

An ultraviolet water treating apparatus 300 according to a third embodiment will be described below with reference to FIGS. 4A and 4B. FIG. 4A is a schematic sectional view illustrating the ultraviolet water treating apparatus 300. FIG. 4B is a view when the apparatus 300 of FIG. 4A is viewed from the direction of an arrow A. In FIGS. 4A and 4B, the same or similar elements as in FIGS. 1A and 1B are labeled with the same reference symbols, and detailed descriptions thereof will be omitted.

In the ultraviolet water treating apparatus 300, the hollow cylindrical enclosure 111 has an outer diameter smaller that the inner diameters of the inlet pipe 120 and outlet pipe 130. Further, the inlet pipe 120 and the outlet pipe 130 are integrated to constitute a single conduit. Namely, in the ultraviolet water treating apparatus 300, the hollow cylindrical enclosure 111 having an outer diameter smaller than the inner diameter of the single conduit is inserted into the single conduit. Further, the flanges 111a and 111b formed in the ultraviolet water treating apparatus 100 are not formed, and the lids 112 and 113 close both the open ends of the hollow cylindrical enclosure through a rubber gasket (not illustrated). The other constructions are the same as in the first embodiment.

According to the third embodiment, the same advantages as those of the first embodiment are exerted, and in addition, the following advantages are exerted. That is, since the ultraviolet irradiation unit 110 is inserted into the single conduit constituted by the inlet pipe 120 and the outlet pipe 130, it is possible to bore two openings in a conduit provided in a conventional water treating plant, insert the ultraviolet irradiation unit 110 into the conduit through the bored openings, and weld the unit 110 to the conduit. Needless to say, the two openings may be bored such that the line connecting the centers of the two openings becomes aslant or perpendicular to the axis of the conduit of the plant (water flow direction). As a result, labor and time required to mount the ultraviolet irradiation unit 110 on the conduit can be largely reduced.

Incidentally, the number of the ultraviolet lamps is not limited to five (in the second embodiment three plus two) noted abode. Further, the combination of a plurality of the ultraviolet lamp units is not limited to the combination described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ultraviolet water treating apparatus comprising:
an ultraviolet irradiation unit comprising
a hollow enclosure having a peripheral wall provided with first and second openings provided oppositely with each other in the peripheral wall,
one or more ultraviolet irradiation devices provided within the hollow enclosure and each comprising an ultraviolet lamp and a protective sleeve surrounding the ultraviolet lamp coaxially with the lamp and provided parallel to each other, the ultraviolet light irradiation device irradiating ultraviolet light onto water flowing through the hollow enclosure, and
a protective sleeve-cleaning device comprising one or more cleaning tools each configured to clean the surface of each protective sleeve, and a driving unit configured to drive the cleaning tool to move it along the protective sleeve, wherein the cleaning device is provided within the enclosure of the ultraviolet light-irradiating unit;
a water inlet pipe configured to flow the water therethrough into the hollow enclosure and provided in fluid communication directly with the first opening of the peripheral wall of the hollow enclosure; and
a water outlet pipe configured to flow the ultraviolet-irradiated water therethrough out of the hollow enclosure,
wherein the water inlet pipe has its central axis intersected with the central axis of the enclosure, and the water outlet pipe has its central axis intersected with the central axis of the enclosure.

2. The ultraviolet water treating apparatus according to claim 1, wherein the enclosure is a hollow cylinder, the both open ends of the cylinder are closed with lids, respectively, and the ultraviolet irradiation device and the cleaning device are fixed at the lids.

3. The ultraviolet water treating apparatus according to claim 2, wherein the cylinder has an inner diameter not smaller than outer diameters of the inlet and outlet pipes.

4. The ultraviolet water treating apparatus according to claim 2, wherein the inlet and outlet pipes constitutes a single conduit, the cylinder has an outer diameter smaller that an inner diameter of the conduit, and the ultraviolet irradiation unit is inserted into the conduit.

5. The ultraviolet water treating apparatus according to claim 1, wherein the hollow enclosure is in a form of a hollow rectangular parallelepiped, the both open ends of the hollow rectangular parallelepiped are closed by lids, the ultraviolet irradiation device and the cleaning device are fixed at the lids, and the inlet and outlet pipes are two walls of the hollow rectangular parallelepiped which face with each other and are perpendicular to the open ends.

6. The ultraviolet water treating apparatus according to claim 5, wherein the parallelepiped has a depth not smaller than outer diameters of the inlet and outlet pipes.

7. The ultraviolet water treating apparatus according to claim 1, wherein the ultraviolet irradiation unit comprises a plurality of ultraviolet irradiation subunits joined to each other, and each ultraviolet irradiation subunit comprises an enclosure in a form of a hollow rectangular parallelepiped containing the ultraviolet irradiation device and the cleaning device.

8. The ultraviolet water treating apparatus according to claim 7, wherein the parallelepiped has a depth not smaller than outer diameters of the inlet and outlet pipes.

9. The ultraviolet water treating apparatus according to claim 5, wherein the inlet and outlet pipes constitutes a single conduit, the parallelepiped has a depth smaller than an inner diameter of the conduit, and the ultraviolet irradiation unit is inserted into the conduit.

10. The ultraviolet water treating apparatus according to claim 7, wherein the inlet and outlet pipes constitutes a single conduit, each parallelepiped has a depth smaller than an inner diameter of the conduit, and the ultraviolet irradiation unit is inserted into the conduit.

11. The ultraviolet water treating apparatus according to claim 1, wherein the ultraviolet lamp is provided by a medium-pressure ultraviolet lamp.

12. The ultraviolet water treating apparatus according to claim 1, an inner diameter of the inlet or outlet pipe is larger than an emission length of the ultraviolet lamp, and the inlet and outlet pipes are connected to the enclosure such that their central axes intersect with a central axis of the enclosure at an acute angle.

13. The ultraviolet water treating apparatus according to claim 1, wherein the ultraviolet lamp is arranged in the protective sleeve such that an emission portion of the ultraviolet lamp is positioned inside a projected outline of the inlet and outlet pipes.
